(19) United States
(12) Patent Application Publication
(10) Pub. No.: US 2025/0197644 A1
(43) Pub. Date: Jun. 19, 2025

(54) ESTER-DISPERSED SILICA SOL AND PRODUCTION METHOD THEREFOR

(71) Applicant: NISSAN CHEMICAL CORPORATION, Tokyo (JP)

(72) Inventors: Keiko YOSHITAKE, Sodegaura-shi (JP); Megumi ARAKI, Sodegaura-shi (JP); Tomoya MAETA, Sodegaura-shi (JP)

(73) Assignee: NISSAN CHEMICAL CORPORATION, Tokyo (JP)

(21) Appl. No.: 18/681,674

(22) PCT Filed: Jul. 27, 2022
(86) PCT No.: PCT/JP2022/028997

§ 371 Date: Aug. 12, 2024

(30) Foreign Application Priority Data
Aug. 6, 2021 (JP) 2021-129555

(51) Int. Cl. C09C 1/30; B01J 13/00

(52) U.S. Cl. CPC C09C 1/3081; B01J 13/0026; C01P 2004/62; C01P 2004/64

(57) ABSTRACT

A silica sol uses a carboxylic acid ester as a dispersion medium and a method for produces the same. The silica sol contains, as dispersoids, silica particles in which an alkoxy group represented by Si—OR¹ is present on or near surfaces of silane-treated silica particles, a solvent containing a carboxylic acid ester having an R²—COO—R¹ structure as a dispersion medium, and an amine. The dispersoids are silica particles in which at least two types of alkoxy groups represented by Si—OR⁰ and Si—OR¹ are present and which have a molar ratio (Si—OR¹)/(Si—OR⁰) of 0.002 to 50. Si—OR⁰ is Si—OCH₃ or Si—OC₂H₅. The silica particles have an average particle diameter of 5 to 200 nm determined by a dynamic light scattering method.

### TECHNICAL FIELD

The present invention relates to a silica sol dispersed in a carboxylic acid ester and a method for producing the same.

### BACKGROUND ART

There have been attempts to improve physical properties of coatings by incorporating silica particles into coating compositions for resins and films and attempts to improve physical properties of cured products by incorporating silica particles into resin matrices. For these, a colloidal silica dispersion (silica sol) is used, but a silica sol (organosilica sol) dispersed in a non-aqueous solvent is used in order to improve compatibility with an organic substance.

For example, a method for producing an organic solvent-dispersed inorganic oxide sol including the following steps (A) and (B) has been disclosed (refer to Patent Document 1),
a step (A) of adding a silicon alkoxide having two or more alkoxy groups bonded to silicon atoms or a silicon alkoxide having a hydroxy group bonded to one or more silicon atoms and an alkoxy group bonded to one or more silicon atoms to a hydrophilic inorganic oxide sol containing 25 to 100% by mass of a hydrophilic solvent having a boiling point of 100° C. or less in a dispersion medium and treating the surfaces of inorganic oxide particles in the sol, and
a step (B) of substituting the dispersion medium of the surface-treated inorganic oxide sol obtained in the step (A), with a non-alcoholic organic solvent in the co-presence of a C₃₋₁₂ primary alcohol.

In this method, a method in which hydroxy groups on the surfaces of inorganic oxide particles such as silica react with an alcohol, alkoxy groups are introduced for obtaining an organic compound, and thereby an inorganic oxide sol dispersed in an organic solvent such as toluene is obtained has been disclosed. For example, a silica sol obtained by reacting a methanol-dispersed silica sol with phenyltrimethoxysilane and dispersing it in a toluene solvent has been disclosed.

A sol (silica sol) in which silica particles having an average particle diameter of 5 to 100 nm in which an organic group containing an unsaturated bond between carbon atoms and an alkoxy group are bonded to the surfaces are dispersed in a ketone solvent, wherein the organic groups containing an unsaturated bond between carbon atoms (0.5 to 2.0 groups/nm²) and the alkoxy groups (0.1 to 2.0 groups/nm²) are bonded at a molar ratio (organic groups containing an unsaturated bond between carbon atoms)/(alkoxy groups) of 0.5 to 5.0 has been disclosed (refer to Patent Document 2).

A method for producing a hydrophobic silica sol whose pH is increased by treating a hydrophobic silica sol with a pH in an acidic range with an alkali has been disclosed (refer to Patent Document 3).

### PRIOR ART DOCUMENTS

### Patent Documents

Patent Document 1: JP 2005-200294 A
Patent Document 2: WO 2020/230823
Patent Document 3: JP H04-92808 A

### SUMMARY OF THE INVENTION

### Problem to be Solved by the Invention

An object of the present invention is to provide a silica sol using a carboxylic acid ester as a dispersion medium and a method for producing the same. The organosilica sol of the present invention can be treated with a silane on the surfaces of silica particles, and a silica sol having improved stability due to addition of an amine is provided.

### Means for Solving the Problem

The present invention provides, as a first aspect, a silica sol which contains, as dispersoids, silica particles in which an alkoxy group represented by Si—OR¹ (provided that R¹ is a C₂₋₁₀ organic group which arbitrarily has an oxygen atom) is present on or near surfaces of silane-treated silica particles, a solvent containing a carboxylic acid ester having an R²—COO—R¹ structure (provided that R¹ is a C₂₋₁₀ organic group which arbitrarily has an oxygen atom, and R² is a C₁₋₁₀ alkyl group which arbitrarily has an oxygen atom) as a dispersion medium, and an amine,
as a second aspect, the silica sol according to the first aspect,
wherein the dispersoids are silica particles in which at least two types of alkoxy groups represented by Si—OR⁰ and Si—OR¹ (provided that R⁰ is a C₁₋₁₀ organic group which arbitrarily has an oxygen atom, R¹ is a C₂₋₁₀ organic group which arbitrarily has an oxygen atom, and R⁰ and R¹ are not the same chemical group) are present on or near the surfaces of the silane-treated silica particles and which have a molar ratio (Si—OR¹)/(Si—OR⁰) of 0.002 to 50,
as a third aspect, the silica sol according to the first aspect or the second aspect,
wherein the silica particles have an average particle diameter of 5 to 200 nm determined by a dynamic light scattering method,
as a fourth aspect, the silica sol according to the first aspect or the second aspect,
wherein R¹ is an ethyl group, n-propyl group, isopropyl group, n-butyl group, isobutyl group, s-butyl group, t-butyl group, 1-methoxy-2-propyl group, 1-ethoxy-2-propyl group, or phenyl group,
as a fifth aspect, the silica sol according to any one of the first aspect to the fourth aspect,
wherein R² is a methyl group, ethyl group, or propyl group,
as a sixth aspect, the silica sol according to any one of the first aspect to the fifth aspect,
wherein a silane treatment of the silica particles is performed with a hydrolysate of at least one silane compound selected from the group consisting of Formula (1) to Formula (3):

R³ₐSi(R⁴)₄₋ₐ Formula (1)

[R⁵_{b}Si(R⁶)_{3-b}]₂Y_{c} Formula (2)

R⁷_{d}Si(R⁸)_{4-d} Formula (3)

(in Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through an Si-C bond, each R⁴ is an alkoxy group, an acyloxy group, or a halogen group, and a is an integer of 1 to 3, and
in Formula (2) and Formula (3), each of R⁵ and R⁷ is a C₁₃ alkyl group or a C₆₋₃₀ aryl group and is bonded to a silicon atom through an Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3),
as a seventh aspect, the silica sol according to the first aspect or the second aspect,
wherein the amine is a secondary amine or tertiary amine having a total number of carbon atoms of 5 to 35,
as an eighth aspect, the silica sol according to the seventh aspect,
wherein pH of a liquid obtained by mixing the silica sol that contains the amine, methanol and pure water at a mass ratio of 1:1:1 to 1:2:1 is 4.0 to 9.5,
as a ninth aspect, a method for producing the silica sol according to any one of the first aspect to the eighth aspect, comprising
the following step (A) to step (B), the following step (A-1) between completion of the step (A) and commencement of the step (B) or during the step (B), and the following step (A-2) after completion of the step (A-1):
   a step (A): a step of obtaining a silica sol containing silica particles having an average particle diameter of 5 to 200 nm determined by a dynamic light scattering method as dispersoids, and an alcohol R⁰OH (provided that R⁰ is a C₁₋₁₀ organic group which arbitrarily has an oxygen atom) as a dispersion medium,
   a step (B): a step of removing some or all of R⁰OH from the silica sol obtained in the step (A) and adding a carboxylic acid ester having an R²—COO—R¹ structure (provided that R¹ is a C₂₋₁₀ organic group which arbitrarily has an oxygen atom, and R² is a C₁₋₁₀ alkyl group),
   a step (A-1): a step of treating the silica particles contained in the silica sol obtained in the step (A) with at least one silane compound of Formula (1) to Formula (3), and
   a step (A-2): a step of adding a secondary amine or tertiary amine having a total number of carbon atoms of 5 to 35 to the silica sol obtained in the step (A-1), and
as a tenth aspect, the method for producing the silica sol according to the ninth aspect,
wherein the step (A) is a step of obtaining a silica sol containing silica particles having an average particle diameter of 5 to 200 nm determined by a dynamic light scattering method as dispersoids, and an alcohol R⁰OH (provided that R⁰ is a C₁₋₁₀ organic group which arbitrarily has an oxygen atom) as a dispersion medium, and
wherein the step (B) is a step of removing some or all of the alcohol R⁰OH of the silica sol obtained in the step (A) and adding a carboxylic acid ester having an R²—COO—R¹ structure (provided that R¹ is a C₂₋₁₀ organic group which arbitrarily has an oxygen atom, R² is a C₁₋₁₀ alkyl group, and R⁰ and R¹ are not the same chemical group).

### Effects of the Invention

Ester solvents, particularly carboxylic acid esters, have been highly evaluated as having environmental performance such as low odor and low toxicity, and a demand for these as alternatives to hydrocarbon and ketone solvents is growing. They have a high utility value such as allowing substitution of ketone solvents with ester solvents, and establishing a solvent recycling system in solvents used in many applications, including applications for dilution of paints, inks, and adhesives, reaction solvents for pharmaceuticals and agricultural chemicals, basic raw materials for derivatives, and cleaning agents.

On the other hand, there have been attempts to improve physical properties of coatings by incorporating silica particles into coating compositions for resins and films and attempts to improve physical properties of cured products by incorporating silica particles into resin matrices.

When improvement in performance is attempted by incorporating silica particles in various applications, since the silica particles are used as colloid particles, aggregation of silica powder is inevitable, and the particles in the form of a colloidal silica dispersion (silica sol) are added to a resin and the like. In this case, a silica sol dispersed in an organic solvent with high compatibility with the resin is used.

The present invention provides a silica sol dispersed in a carboxylic acid ester solvent having a high utility value as a solvent.

An organosilica sol is generally produced by dispersing a silica sol (aqueous silica sol) in an aqueous solvent, a dispersion medium is solvent-substituted with a lower alcohol (for example, methanol) instead of water, and additionally substituted with a desired carboxylic acid ester solvent, and thus a silica sol using a carboxylic acid ester as a dispersion medium is obtained.

In the present invention, it has been found that, when a group including a chemical group adjacent to the ester group of the carboxylic acid ester is present as an alkoxy group on or near the surfaces of silica particles, the stability of dispersion in the carboxylic acid ester solvent is improved.

On or near the surfaces of silica particles, at least an organic group (R¹ group) adjacent to an ester group of carboxylic acid ester is present as a silanol group (Si—OR¹ group) according to transesterification, and thus silica particles with high dispersibility in the ester solvent are obtained.

In addition, silica particles have silanol groups on the surfaces, and it is known that, when the dispersion medium is substituted with, for example, methanol, instead of water, hydroxyl groups of the silanol are converted into methoxy groups. Further, when the dispersion medium is substituted with carboxylic acid ester instead of methanol, according to transesterification between the methoxy group and the carboxylic acid ester, silanol groups on or near the surfaces of silica particles are substituted with at least two types of alkoxy groups. For example, there are at least two types of alkoxy groups: methoxy groups and alkoxy groups according to the ester organic group.

The abundance proportion of these at least two types of alkoxy groups greatly influences the stability of the silica sol using a carboxylic acid ester as a dispersion medium.

The transesterification is easily promoted on the acidic side, and the hydrolysis of alkoxy groups is also easily promoted on the acidic side, and thus it is preferable to maintain the dispersion medium on the alkaline side, and this can be achieved by, for example, incorporation of an amine compound.

In the silica sol using a carboxylic acid ester as a dispersion medium, the surfaces of silica particles is treated with a silane compound, and thus functional groups that are not converted into silanol are bonded by covalent bonds, which contributes to the stability of the silica sol using a carboxylic acid ester as a dispersion medium.

### MODES FOR CARRYING OUT THE INVENTION

The present invention provides a silica sol, which contains, as dispersoids, silica particles in which an alkoxy group represented by Si—OR¹ (provided that R¹ is a C₂₋₁₀ organic group which arbitrarily has an oxygen atom) is present on or near surfaces of silane-treated silica particles, a solvent containing a carboxylic acid ester having an R²—COO—R¹ structure (provided that R¹ is a C₂₋₁₀ organic group which arbitrarily has an oxygen atom, and R² is a C₁₋₁₀ alkyl group which arbitrarily has an oxygen atom) as a dispersion medium, and an amine.

In addition, the present invention provides a silica sol which contains, as dispersoids, silica particles containing at least two types of alkoxy groups represented by Si—OR⁰ and Si—OR¹ (provided that R⁰ is a C₁₋₁₀ organic group which arbitrarily has an oxygen atom, and moreover R⁰ is a C₁₄ alkyl group, R¹ is a C₂₋₁₀ organic group which arbitrarily has an oxygen atom, and R⁰ and R¹ are not the same chemical group) at a molar ratio (Si—OR¹)/(Si—OR⁰) of 0.002 to 50 on or near the surfaces of silane-treated silica particles, a solvent containing a carboxylic acid ester having an R²—COO—R¹ structure (provided that R¹ is a C₂₋₁₀ organic group which arbitrarily has an oxygen atom, and R² is a C₁₋₁₀ alkyl group which arbitrarily has an oxygen atom) as a dispersion medium, and an amine.

The molar ratio (Si—OR¹)/(Si—OR⁰) can be in a range of 0.002 to 50, or 0.01 to 40.

In Si—OR⁰ and Si—OR¹, R⁰ and R¹ are not the same chemical group. That is, if Si—OR⁰ is Si—OCH₃, in Si—OR¹, R¹ is other than a methyl group and is a C₂₋₁₀ organic group which arbitrarily has an oxygen atom.

In addition, the number of carbon atoms can also have the relationship of R⁰<R¹. When the number of carbon atoms has the relationship of R⁰<R¹, in the relationship between Si—OR⁰ and Si—OR¹, if Si—OR⁰ is Si—OCH₃, Si—OR¹ indicates that R¹ is an organic group having a carbon atom number that is equal to or larger than that of the ethyl group, and indicates an organic group having a carbon atom number of up to 10, which arbitrarily has an oxygen atom, from an ethyl group.

Si—OR⁰ and Si—OR¹ are alkoxy groups that are generated by a reversible reaction between the hydroxyl group of the silanol group on the surfaces of silica particles and an alcohol when the aqueous medium which is a dispersion medium of an aqueous silica sol is substituted with the alcohol.

Si—OR⁰ can indicate, for example, Si—OCH₃, Si—OC₂H₅, or Si—OC₃H₇, and is preferably Si—OCH₃ or Si—OC₂H₅, and particularly, Si—OCH₃ is a preferable example.

In addition, the Si—OR¹ group (provided that R¹ is a C₂₋₁₀ organic group which arbitrarily has an oxygen atom) is an alkoxy group according to transesterification that occurs reversibly between Si—OR¹ and R²—COO—R¹ when the alcohol of the dispersion medium is substituted with a carboxylic acid ester having an R²—COO—R¹ structure. When R¹s are the same organic group, an Si—OR¹ group is formed on or near the surfaces of silica particles.

In addition, the present invention provides a silica sol which contains, as dispersoids, silica particles containing at least two types of alkoxy groups represented by Si—OR⁰ (R⁰ is a C₁₄ alkyl group) and Si—OR¹ (provided that R¹ is a C₂₋₁₀ organic group which arbitrarily has an oxygen atom, and R⁰ and R¹ are not the same chemical group) at a molar ratio (Si—OR¹)/(Si—OR⁰) of 0.002 to 50 and particularly at a molar ratio (Si—OR¹)/(Si—OCH₃) of 0.002 to 50 on or near the surfaces of silane-treated silica particles, a solvent containing a carboxylic acid ester having an R²—COO—R¹ structure (provided that R¹ is a C₂₋₁₀ organic group which arbitrarily has an oxygen atom, and R² is a C₁₋₁₀ alkyl group which arbitrarily has an oxygen atom) as a dispersion medium, and an amine.

Si—OR⁰ (particularly, Si—OCH₃) is an alkoxy group that is generated according to a reversible reaction between the hydroxyl group of the silanol group on the surfaces of silica particles and R⁰OH when the aqueous medium which is a dispersion medium of an aqueous silica sol is substituted with R⁰OH.

In addition, the Si—OR¹ group (provided that R¹ is a C₂₋₁₀ organic group which arbitrarily has an oxygen atom) is an alkoxy group according to transesterification that occurs reversibly between Si—OR⁰ and R²—COO—R¹ when R⁰OH (particularly, methanol) of the dispersion medium is substituted with a carboxylic acid ester having an R²—COO—R¹ structure.

In the present invention, silica particles have a molar ratio (Si—OR¹)/(Si—OR⁰) of 0.002 to 50, and particularly silica particles having a molar ratio (Si—OR¹)/(Si—OCH₃) of 0.002 to 50 are preferable.

In the carboxylic acid ester having an R²—COO—R¹ structure, R¹ is a C₂₋₁₀ organic group which arbitrarily has an oxygen atom, and R² is a C₁₋₁₀ alkyl group which arbitrarily has an oxygen atom. The oxygen atom can be present in the form of an ether bond or hydroxy group.

Examples of R¹ include ethyl group, n-propyl group, i-propyl group, n-butyl group, isobutyl group, s-butyl group, t-butyl group, n-pentyl group, isopentyl group, 1-methoxy-2-propyl group, 1-ethoxy-2-propyl group, 1-propoxy-2-propyl group, 2-ethoxyethyl group, 2-hydroxyethyl group, 1-hydroxy-2-ethyl group, 3-methoxybutyl group, and phenyl group. For R¹, ethyl group, n-propyl group, isopropyl group, n-butyl group, t-butyl group, 1-methoxy-2-propyl group, 1-ethoxy-2-propyl group, and phenyl group are preferably used.

Examples of R² include methyl group, ethyl group, 1-hydroxyethyl group, and propyl group. For R², methyl group, ethyl group, and propyl group are preferably used.

Examples of carboxylic acid esters having an R²—COO—R¹ structure include ethyl acetate, butyl acetate, sec-butyl acetate, methoxybutyl acetate, amyl acetate, n-propyl acetate, isopropyl acetate, ethyl lactate, butyl lactate, ethylene glycol monomethyl ether acetate, propylene glycol monomethyl ether acetate, propylene glycol monoethyl ether acetate, propylene glycol monopropyl ether acetate, phenyl acetate, phenyl lactate, and phenyl propionate.

The sol of the present invention has a solid content of 0.1 to 60% by mass, or 1 to 55% by mass, or 10 to 55% by mass. Here, the solid content is obtained by removing the solvent component from all components of the sol.

In the sol of the present invention, the average particle diameter of silica particles determined by a dynamic light scattering method (DLS method) is in a range of 5 to 200 nm or 5 to 150 nm, and the average primary particle diameter of silica particles observed under a transmission electron microscope is in a range of 5 to 200 nm, 5 to 150 nm, or 5 to 100 nm.

The silica sol of the present invention is obtained through the following step (A) to step (B):
a step (A): a step of obtaining a silica sol containing silica particles having an average particle diameter of 5 to 200 nm determined by a dynamic light scattering method as dispersoids, and an alcohol R⁰OH (provided that R⁰ is a C₁₋₁₀ organic group which arbitrarily has an oxygen atom) as a dispersion medium,
a step (B): a step of removing some or all of R⁰OH from the silica sol obtained in the step (A) and adding a carboxylic acid ester having an R²—COO—R¹ structure (provided that R¹ is a C₂₋₁₀ organic group which arbitrarily has an oxygen atom, and R² is a C₁₋₁₀ alkyl group).

Here, in the production method,
the step (A) may be a step of obtaining a silica sol containing silica particles having an average particle diameter of 5 to 200 nm determined by a dynamic light scattering method as dispersoids, and an alcohol R⁰OH (provided that R⁰ is a C₁₋₁₀ organic group which arbitrarily has an oxygen atom) as a dispersion medium, and
the step (B) may be a step of removing some or all of the alcohol R⁰OH from the silica sol obtained in the step (A) and adding a carboxylic acid ester having an R²—COO—R¹ structure (provided that R¹ is a C₂₋₁₀ organic group which arbitrarily has an oxygen atom, R² is a C₁₋₁₀ alkyl group, and R⁰ and R¹ are not the same chemical group).

In addition, the number of carbon atoms can also have the relationship of R⁰<R¹.

For the silica sol in the step (A), a silica sol using a C₁₋₄ alcohol R⁰OH as a dispersion medium can be used. Examples of alcohols include methanol, ethanol, n-propanol, i-propanol, and propylene glycol monomethyl ether. Particularly, the alcohol is preferably methanol.

A silica sol using a C₁₋₄ alcohol R⁰OH as a dispersion medium is obtained using an aqueous silica sol as a starting raw material. The aqueous silica sol is obtained using water glass as a starting raw material through a step a) of cation-exchanging water glass to obtain an activated silicic acid, and a step b) of heating the activated silicic acid to obtain silica particles. In the step a), an activated silicic acid in which, in order to increase the purity of the activated silicic acid, a mineral acid (for example, hydrochloric acid, nitric acid, or sulfuric acid) is added, metal impurities other than silica are eluted, and metal impurities and unnecessary anions are removed by cation exchange and anion exchange can be used. In the step b), an alkali component (for example, NaOH, KOH) is added to the activated silicic acid to grow silica particles. In order to promote growth of silica particles, a seed liquid in which an alkali is added to the activated silicic acid obtained in the step a) and a feed liquid are prepared, and while heating the seed liquid, the feed liquid is supplied to increase the diameter of the silica particles, and thus an aqueous silica sol having an arbitrary particle diameter can be obtained.

More preferably, within the alkali component added in the step b), an acidic silica sol from which alkali ions existing outside the particles have been removed is suitable as a starting raw material of the present invention.

In the step (A) of the present invention, it is possible to obtain a silica sol in which an aqueous medium of an aqueous silica sol is solvent-substituted with a C₁₋₄ alcohol R⁰OH (provided that R⁰ is a C₁₋₄ alkyl group, and the alcohol is particularly methanol), silica particles having an average particle diameter of 5 to 200 nm determined by a dynamic light scattering method are used as dispersoids, and a C₁₋₄ alcohol is used as a dispersion medium.

The step (B) is a step of removing some or all of a C₁₋₄ alcohol R⁰OH (provided that R⁰ is a C₁₋₄ alkyl group, and the alcohol is particularly methanol) from the silica sol obtained in the step (A) and adding a carboxylic acid ester having an R²—COO—R¹ structure (provided that R¹ is a C₂₋₁₀ organic group which arbitrarily has an oxygen atom, and R² is a C₁₋₁₀ alkyl group).

Removal of some or all of R⁰OH (particularly, methanol) and addition of a carboxylic acid ester having an R²—COO—R¹ structure are also so-called solvent substitution, but it is not necessary to completely remove R⁰OH, it is possible to remove R⁰OH in the subsequent step, and some R⁰OH can remain. Removal of R⁰OH and addition of a carboxylic acid ester having an R²—COO—R¹ structure can both be performed at the same time or either one can be performed first.

The solvent substitution can be performed by an evaporation method or ultrafiltration method. For example, the silica sol using R⁰OH as a dispersion medium, obtained in the step (A) is put into a flask in a warm bath at 50 to 100° C., and a carboxylic acid ester can be added at a liquid temperature of 40 to 90° C. in the flask to perform solvent substitution. Solvent substitution can be performed under a normal pressure or under a reduced pressure. It can be performed under a reduced pressure, for example, at a pressure of 50 to 600 Torr. The time required for solvent substitution can be about 0.1 to 10 hours.

In the present invention, the following step (A-1) may be provided between completion of the step (A) and commencement of the step (B) or during the step (B):

The step (A-1): a step of treating the silica sol obtained in the step (A) with a hydrolysate of at least one silane compound selected from the group consisting of those of Formula (1) to Formula (3).

In Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through an Si—C bond, each R⁴ is an alkoxy group, an acyloxy group, or a halogen group, and a is an integer of 1 to 3, and
in Formula (2) and Formula (3), each of R⁵ and R⁷ is a C₁₋₃ alkyl group or a C₆₋₃₀ aryl group and is bonded to a silicon atom through an Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3.

The alkyl group is a C₁₋₁₈ alkyl group, and examples thereof include, but are not limited to, methyl group, ethyl group, n-propyl group, i-propyl group, cyclopropyl group, n-butyl group, i-butyl group, s-butyl group, t-butyl group, cyclobutyl group, 1-methyl-cyclopropyl group, 2-methyl-cyclopropyl group, n-pentyl group, 1-methyl-n-butyl group, 2-methyl-n-butyl group, 3-methyl-n-butyl group, 1,1-dimethyl-n-propyl group, 1,2-dimethyl-n-propyl group, 2,2-dimethyl-n-propyl group, 1-ethyl-n-propyl group, cyclopentyl group, 1-methyl-cyclobutyl group, 2-methyl-cyclobutyl group, 3-methyl-cyclobutyl group, 1,2-dimethyl-cyclopropyl group, 2,3-dimethyl-cyclopropyl group, 1-ethyl-cyclopropyl group, 2-ethyl-cyclopropyl group, n-hexyl group, 1-methyl-n-pentyl group, 2-methyl-n-pentyl group, 3-methyl-n-pentyl group, 4-methyl-n-pentyl group, 1,1-dimethyl-n-butyl group, 1,2-dimethyl-n-butyl group, 1,3-dimethyl-n-butyl group, 2,2-dimethyl-n-butyl group, 2,3-dimethyl-n-butyl group, 3,3-dimethyl-n-butyl group, 1-ethyl-n-butyl group, 2-ethyl-n-butyl group, 1,1,2-trimethyl-n-propyl group, 1,2,2-trimethyl-n-propyl group, 1-ethyl-1-methyl-n-propyl group, 1-ethyl-2-methyl-n-propyl group, cyclohexyl group, 1-methyl-cyclopentyl group, 2-methyl-cyclopentyl group, 3-methyl-cyclopentyl group, 1-ethyl-cyclobutyl group, 2-ethyl-cyclobutyl group, 3-ethyl-cyclobutyl group, 1,2-dimethyl-cyclobutyl group, 1,3-dimethyl-cyclobutyl group, 2,2-dimethyl-cyclobutyl group, 2,3-dimethyl-cyclobutyl group, 2,4-dimethyl-cyclobutyl group, 3,3-dimethyl-cyclobutyl group, 1-n-propyl-cyclopropyl group, 2-n-propyl-cyclopropyl group, 1-i-propyl-cyclopropyl group, 2-i-propyl-cyclopropyl group, 1,2,2-trimethyl-cyclopropyl group, 1,2,3-trimethyl-cyclopropyl group, 2,2,3-trimethyl-cyclopropyl group, 1-ethyl-2-methyl-cyclopropyl group, 2-ethyl-1-methyl-cyclopropyl group, 2-ethyl-2-methyl-cyclopropyl group and 2-ethyl-3-methyl-cyclopropyl group, hexyl group, heptyl group, octyl group, nonyl group, decyl group, undecyl group, dodecyl group, tridecyl group, tetradecyl group, pentadecyl group, hexadecyl group, heptadecyl group, and octadecyl group.

In addition, the alkylene group may be an alkylene group derived from the above alkyl group.

The aryl group is a C₆₋₃₀ aryl group, and examples thereof include phenyl group, naphthyl group, anthracene group, and pyrene group.

The alkenyl group is a C₂₋₁₀ alkenyl group, and examples thereof include, but are not limited to, ethenyl group, 1-propenyl group, 2-propenyl group, 1-methyl-1-ethenyl group, 1-butenyl group, 2-butenyl group, 3-butenyl group, 2-methyl-1-propenyl group, 2-methyl-2-propenyl group, 1-ethylethenyl group, 1-methyl-1-propenyl group, 1-methyl-2-propenyl group, 1-pentenyl group, 2-pentenyl group, 3-pentenyl group, 4-pentenyl group, 1-n-propylethenyl group, 1-methyl-1-butenyl group, 1-methyl-2-butenyl group, 1-methyl-3-butenyl group, 2-ethyl-2-propenyl group, 2-methyl-1-butenyl group, 2-methyl-2-butenyl group, 2-methyl-3-butenyl group, 3-methyl-1-butenyl group, 3-methyl-2-butenyl group, 3-methyl-3-butenyl group, 1,1-dimethyl-2-propenyl group, 1-i-propylethenyl group, 1,2-dimethyl-1-propenyl group, 1,2-dimethyl-2-propenyl group, 1-cyclopentenyl group, 2-cyclopentenyl group, 3-cyclopentenyl group, 1-hexenyl group, 2-hexenyl group, 3-hexenyl group, 4-hexenyl group, 5-hexenyl group, 1-methyl-1-pentenyl group, 1-methyl-2-pentenyl group, 1-methyl-3-pentenyl group, 1-methyl-4-pentenyl group, 1-n-butylethenyl group, 2-methyl-1-pentenyl group, and 2-methyl-2-pentenyl group.

Examples of alkoxy groups include a C₁₋₁₀ alkoxy group, such as methoxy group, ethoxy group, n-propoxy group, i-propoxy group, n-butoxy group, i-butoxy group, s-butoxy group, t-butoxy group, n-pentyloxy group, 1-methyl-n-butoxy group, 2-methyl-n-butoxy group, 3-methyl-n-butoxy group, 1,1-dimethyl-n-propoxy group, 1,2-dimethyl-n-propoxy group, 2,2-dimethyl-n-propoxy group, 1-ethyl-n-propoxy group, and n-hexyloxy group, but are not limited thereto.

Examples of acyloxy groups include a C₂₋₁₀ acyloxy group, such as methylcarbonyloxy group, ethylcarbonyloxy group, n-propylcarbonyloxy group, i-propylcarbonyloxy group, n-butyl carbonyloxygroup, i-butyl carbonyloxygroup, s-butyl carbonyloxygroup, t-butyl carbonyloxygroup, n-pentylcarbonyloxy group, 1-methyl-n-butyl carbonyloxygroup, 2-methyl-n-butyl carbonyloxygroup, 3-methyl-n-butyl carbonyloxygroup, 1,1-dimethyl-n-propylcarbonyloxy group, 1,2-dimethyl-n-propylcarbonyloxy group, 2,2-dimethyl-n-propylcarbonyloxy group, 1-ethyl-n-propylcarbonyloxy group, n-hexyl carbonyloxy group, 1-methyl-n-pentylcarbonyloxy group, and 2-methyl-n-pentylcarbonyloxy group, but are not limited thereto.

Examples of halogen groups include fluorine, chlorine, bromine, and iodine.

Examples of organic groups having an epoxy group include 2-(3,4-epoxycyclohexyl)ethyl group and 3-glycidoxypropyl group.

The (meth)acryloyl group represents both an acryloyl group and a methacryloyl group. Examples of organic groups having a (meth)acryloyl group include 3-methacryloxypropyl group and 3-acryloxypropyl group.

Examples of organic groups having a mercapto group include 3-mercaptopropyl group.

Examples of organic groups having an amino group include 2-aminoethyl group, 3-aminopropyl group, N-2-(aminoethyl)-3-aminopropyl group, N-(1,3-dimethyl-butylidene)aminopropyl group, N-phenyl-3-aminopropyl group, and N-(vinylbenzyl)-2-aminoethyl-3-aminopropyl group.

Examples of organic groups having a ureido group include 3-ureidopropyl group.

Examples of organic groups having a cyano group include 3-cyanopropyl group.

The compound of each of Formula (2) and Formula (3) is preferably a compound that can form a trimethylsilyl group on or near the surfaces of silica particles.

Example of such a compound include those of the following Formulae.

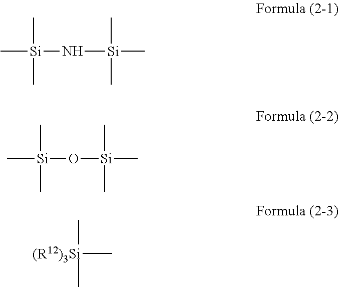

In the above formula, R¹² is an alkoxy group, and examples thereof include methoxy group and ethoxy group.

This is a step in which a hydroxy group on the surfaces of silica particles (e.g. silanol group in the case of silica particles) is reacted with the silane compound, to thereby treat the surfaces of the silica particles with the silane compound via a siloxane bond. The reaction temperature can be from 20° C. to a boiling point of the dispersion medium, and for example, the reaction can be performed in a range of 20° C. to 100° C. The reaction can be performed for a reaction time of about 0.1 to 6 hours.

Examples of preferable functional groups include trimethylsilyl group, monomethylsilyl group, dimethylsilyl group, methacryloxypropylsilyl group, and phenyl group, and examples of corresponding silane compounds include hexamethyldisilazane, hexamethylsiloxane, hexamethyldisiloxane, methyltrimethoxysilane, dimethyldimethoxysilane, methyltriethoxysilane, methacryloxypropyltrimethoxysilane, methacryloxypropyltriethoxysilane, acryloxypropyltrimethoxysilane, acryloxypropyltriethoxysilane, phenyltrimethoxysilane, and phenyltriethoxysilane.

Regarding the amount of the silane compound for treating the surfaces of silica particles, a silane compound corresponding to a treating amount in which the number of silicon atoms in the silane compound is 0.1 atoms/nm² to 6.0 atoms/nm² can be added to the silica sol to treat the surfaces of silica particles.

Water is required for hydrolysis of the silane compound, but if the sol is in an aqueous solvent, such an aqueous solvent is used, and if the sol is a C₁₋₄ alcohol R⁰OH solvent, water remaining in the alcohol solvent when the aqueous medium is solvent-substituted with an alcohol can be used. The residual water is water remaining when the sol of the aqueous medium is solvent-substituted with the sol of a C₁₋₄ alcohol solvent, and for example, water present in the alcohol at 1% by mass or less, for example, 0.01 to 1% by mass can be used. In addition, hydrolysis can be performed with or without a catalyst.

When hydrolysis is performed without a catalyst, the surfaces of silica particles may be on the acidic side, and a methanol silica sol having a pH of 2 to 6 (measured when methanol and water are contained at 1:1) can be used.

When a catalyst is used, examples of hydrolysis catalysts include metal chelate compounds, organic acids, inorganic acids, organic bases, and inorganic bases. Examples of metal chelate compounds as hydrolysis catalysts include triethoxy-mono(acetylacetonato) titanium, and triethoxy-mono(acetylacetonato) zirconium. Examples of organic acids as hydrolysis catalysts include acetic acid and oxalic acid. Examples of inorganic acids as hydrolysis catalysts include hydrochloric acid, nitric acid, sulfuric acid, hydrofluoric acid, and phosphoric acid. Examples of organic bases as hydrolysis catalysts include pyridine, pyrrole, piperazine, and quaternary ammonium salts. Examples of inorganic bases as hydrolysis catalysts include ammonia, sodium hydroxide, and potassium hydroxide.

The present invention can include the following step (A-2) after the step (A-1) is completed:
the step (A-2): a step of adding a secondary amine or tertiary amine having a total number of carbon atoms of 5 to 35 to the silica sol obtained in the step (A-1).

The content of the amine can be set to 0.01 to 10.0 mmol or 0.01 to 5.0 mmol per 100 g of SiO₂ of silica particles.

In addition, the amount of an amine added is preferably an amount at which the pH of the silica sol is 4.0 to 9.5, and more preferably an amount at which the pH of the silica sol is 4.0 to 7.5. The amount of the amine added is present as a content in the silica sol. The pH of the ester-dispersed silica sol of the present invention is determined by measuring a liquid obtained by mixing a silica sol, methanol and pure water at a mass ratio of 1:1:1 to 1:2:1.

Examples of secondary amines include n-ethylpropylamine, ethylisopropylamine, dipropylamine, diisopropylamine, ethylbutylamine, n-propylbutylamine, dibutylamine, ethylpentylamine, n-propylpentylamine, isopropylpentylamine, dipentylamine, ethyloctyl amine, i-propyloctyl amine, butyloctylamine, and dioctylamine.

Examples of tertiary amines include triethylamine, ethyl-di-n-propylamine, diethyl-n-propylamine, tri-n-propylamine, triisopropylamine, ethyldibutylamine, diethylbutylamine, isopropyldibutylamine, diisopropylethylamine, diisopropylbutylamine, tributylamine, ethyldipentylamine, diethylpentylamine, tripentylamine, methyldioctylamine, dimethyloctyl amine, ethyldioctylamine, diethyloctyl amine, trioctyl amine, benzyldibutylamine, and diazabicycloundesene.

Among the above amines, secondary amines and tertiary amines having an alkyl group having a total number of carbon atoms of 6 to 35 are preferable, and examples thereof include diisopropylamine, tripentylamine, triisopropylamine, dimethyloctyl amine, and trioctyl amine.

In the present invention, since the silica sol uses a carboxylic acid ester as a dispersion medium, it is preferable that the silica particles have irreversible hydrophobic groups on the surfaces. Therefore, it is preferable to perform treatment with a hydrolysate of at least one of silane compounds of Formula (1) to Formula (3). This silane treatment is performed on the acidic side.

In addition, in an example of solvent substitution from a methanol solvent sol to a carboxylic acid ester sol, some silanol groups on the surfaces of silica particles are converted into methoxy groups in the methanol solvent, but when the methanol solvent is substituted with a carboxylic acid ester, the methyl groups of the methoxy groups are converted into alkoxy groups according to transesterification with alkyl groups adjacent to the ester bond of the carboxylic acid ester. When the number of alkoxy groups increases, the interparticle repulsion decreases and aggregation tends to occur. This reaction is promoted on the acidic side, but transesterification is stopped by adding the amine, and silica particles having a molar ratio (Si—OR¹)/(Si—OR⁰) of 0.002 to 50 and particularly a molar ratio (Si—OR¹)/(Si—OCH₃) of 0.002 to 50 are obtained.

In addition, in an example of solvent substitution from a methanol solvent sol to a propylene glycol monomethyl ether acetate solvent sol, in the methanol solvent sol, silanol groups and methoxy groups are present on the surfaces of silica particles, and according to transesterification by substituting the solvent with propylene glycol monomethyl ether acetate, 1-methoxy-2-propoxy groups are present, but some methoxy groups return to methanol due to the acidity of silanol groups, and a mixture of methanol and propylene glycol monomethyl ether is present in the carboxylic acid ester solvent. The amine is necessary to control the acidity of the silanol.

The present invention provides a silica sol dispersed in a carboxylic acid ester and can be used for, for example, adhesives, mold-releasing agents, semiconductor encapsulants, LED encapsulants, paints, film internal additives, hard coating agents, photoresist materials, printing inks, cleaning agents, cleaners, various resin additives, insulating compositions, anti-rust agents, lubricating oils, metal processing oils, film coating agents, and release agents.

### EXAMPLES

### (Analysis Method of Particle-Bonded Alcohol)

20 ml of n-hexane was added to 4 ml of a sample, and after centrifugation (2770G), the supernatant was removed and the precipitate was separated. In addition, after the precipitate was re-dissolved by adding 2 to 4 ml of acetone, an operation of adding n-hexane again until aggregation occurred and separating the precipitate by centrifugation (2770G) was performed twice. The obtained precipitate was vacuum-dried at 150° C. to obtain a dry powder.

0.2 g of the powder obtained above was mixed with 10 ml of a 0.05 N sodium hydroxide aqueous solution and left at room temperature for 1 day. Then, if there was any undissolved material, it was removed by filtration or centrifugation, the solution portion was subjected to gas chromatography measurement, and thus the amount of the alcohol bonded to the surface was measured.

### Example 1

A methanol-dispersed silica sol (with an average primary particle diameter of 45 nm determined by a BET method, silica concentration of 40.5% by mass, 1.5% of water, commercially available from Nissan Chemical Corporation) was prepared.

900 g of the methanol sol was put into a 2 L eggplant flask, and while stirring the sol with a magnetic stirrer, 9.0 g of hexamethyldisiloxane was added, and the mixture was then maintained at a liquid temperature of 60° C. for 2 hours.

Then, 360 g of propylene glycol monomethyl ether acetate (PGMEA) was supplied while the solvent was distilled off by evaporation in a rotary evaporator at a pressure of 500 Torr and a bath temperature of 80° C., and a part of the dispersion medium of the sol was substituted with PGMEA. While stirring the sol with a magnetic stirrer, 9.0 g of hexamethyldisiloxane was added, and the mixture was then maintained at a liquid temperature of 60° C. for 2 hours.

Then, PGMEA was supplied while the solvent was distilled off by evaporation in a rotary evaporator at a pressure of 400 to 100 Torr and a bath temperature of 80° C., and the dispersion medium of the sol was substituted with PGMEA. While stirring the sol after substitution with a magnetic stirrer, 1.42 g (1.1 mmol per 100 g of SiO₂ of silica particles) of tri-n-octyl amine was added to obtain a PGMEA-dispersed silica sol (30.1% by mass of SiO₂, a viscosity (20° C.) of 4.9 mPa·s, 0.2% by mass of water, 0.2% by mass of methanol, an average particle diameter (determined by a dynamic light scattering method) of 87 nm of silica particles, an amount of trimethylsilyl groups bonded to silica particles of 1.1 groups/nm², an amount of methoxy groups bonded to silica particles of 0.4 groups/nm², and an amount of 1-methoxy-2-propoxy groups bonded to silica particles of 0.06 groups/nm²). The molar ratio (Si—OR¹)/(Si—OR⁰) was 0.15. However, —OR¹ is a 1-methoxy-2-propoxy group, and —OR⁰ is a methoxy group.

The pH of a liquid obtained by mixing the silica sol, methanol and pure water at a mass ratio of 1:1:1 was measured with a pH meter and found to be 4.8.

Even after this sol was put into a sealed glass container and maintained at room temperature or 50° C. for 4 weeks, there was no increase in viscosity.

### Example 2

A methanol-dispersed silica sol in the form of chain particles (with an average primary particle diameter of 11 nm determined by a BET method, a silica concentration of 20.5% by mass, and 1.5% of water, commercially available from Nissan Chemical Corporation) was prepared.

1,000 g of the methanol sol was put into a 2 L eggplant flask, and while stirring the sol with a magnetic stirrer, 10.0 g of hexamethyldisiloxane was added and the mixture was then maintained at a liquid temperature of 60° C. for 2 hours.

Then, 450 g of propylene glycol monomethyl ether acetate (PGMEA) was supplied while the solvent was distilled off by evaporation in a rotary evaporator at a pressure of 400 Torr and a bath temperature of 80° C., and a part of the dispersion medium of the sol was substituted with PGMEA. Then, while stirring the sol with a magnetic stirrer, 10.0 g of hexamethyldisiloxane was added, the mixture was then maintained at a liquid temperature of 60° C. for 2 hours, and after cooling, 0.62 g (1.3 mmol per 100 g of SiO₂ of silica particles) of tri-n-pentylamine was added with stirring.

Then, PGMEA was supplied while the solvent was distilled off by evaporation in a rotary evaporator at a pressure of 400 to 80 Torr and a bath temperature of 80 to 90° C., and the dispersion medium of the sol was substituted with PGMEA to obtain a PGMEA-dispersed silica sol (18.2% by mass of SiO₂, a viscosity (20° C.) of 8.4 mPa·s, 0.1% by mass of water, 0.1% by mass of methanol, an average particle diameter (determined by a dynamic light scattering method) of 39 nm of silica particles, an amount of trimethylsilyl groups bonded to silica particles of 1.4 groups/nm², an amount of methoxy groups bonded to silica particles of 0.35 groups/nm², and an amount of 1-methoxy-2-propoxy groups bonded to silica particles of 0.08 groups/nm²). The molar ratio (Si—OR¹)/(Si—OR⁰) was 0.23. However, —OR¹ is a 1-methoxy-2-propoxy group, and —OR⁰ is a methoxy group.

In addition, the content of the amine was 1.49 mmol per 100 g of SiO₂ of silica particles.

The pH of a liquid obtained by mixing the silica sol, methanol and pure water at a mass ratio of 1:1:1 was measured with a pH meter and found to be 5.6.

Even after this sol was put into a sealed glass container and maintained at room temperature or 50° C. for 4 weeks, there was no increase in viscosity.

### Example 3

A water-dispersed silica sol (with an average primary particle diameter of 11 nm determined by a BET method, a pH of 3, and a silica concentration of 33% by mass, commercially available from Nissan Chemical Corporation) was prepared.

1,000 g of the silica sol was put into a glass reactor with an inner volume of 2 L including a stirrer, a condenser, a thermometer and two inlets, and while the sol in the reactor was maintained in a boiling state, methanol vapor generated in another boiler was continuously blown into the silica sol in the reactor, and water was substituted with methanol while gradually raising the liquid level. When the volume of the distillate reached 9 L, the substitution was completed, and 1,100 g of a methanol-dispersed silica sol was obtained. The obtained methanol-dispersed silica sol had an SiO₂ concentration of 30.5% by mass, 1.6% by mass of water, and a viscosity of 2 mPa·s.

1,000 g of the methanol sol was put into a 2 L eggplant flask, and while stirring the sol with a magnetic stirrer, 150 g of n-butyl alcohol and 77.5 g of methyltrimethoxysilane (product name KBM-13, commercially available from Shin-Etsu Chemical Co., Ltd.) were added and the mixture was then maintained at a liquid temperature of 60° C. for 5 hours. Then, n-butyl acetate was supplied while the solvent was distilled off by evaporation in a rotary evaporator at a pressure of 500 to 80 Torr and a bath temperature of 80° C., the dispersion medium of the sol was substituted with n-butyl acetate, and 0.06 g (0.9 mmol per 100 g of SiO₂ of silica particles) of tri-n-pentylamine was then added to obtain a transparent colloid-colored n-butyl acetate-dispersed silica sol (40.5% by mass of SiO₂, a viscosity (20° C.) of 3.2 mPa·s, 0.02% by mass of water, 0.02% by mass of methanol, 4% by mass of n-butyl alcohol, an average particle diameter (determined by a dynamic light scattering method) of 19 nm of silica particles measured after dilution with n-butyl acetate, an amount of methoxy groups bonded to silica particles of 0.44 groups/nm², and an amount of butoxy groups bonded to silica particles of 0.71 groups/nm²). The molar ratio (Si—OR¹)/(Si—OR⁰) was 1.61. However, —OR¹ is a butoxy group, and —OR⁰ is a methoxy group.

The pH of a liquid obtained by mixing the silica sol, methanol and pure water at a mass ratio of 1:2:1 was measured with a pH meter and found to be 5.3.

Even after this sol was put into a sealed glass container and maintained at 50° C. for 4 weeks, there was no increase in viscosity.

### Example 4

750 g of the methanol-dispersed silica sol prepared in the same manner as in Example 3 was put into a 1 L eggplant flask, and while stirring the sol with a magnetic stirrer, 63.2 g of n-butyl alcohol and 58.2 g of methyltrimethoxysilane (product name KBM-13, commercially available from Shin-Etsu Chemical Co., Ltd.) were added, the mixture was heated at a liquid temperature of 60° C. for 5 hours, 17.0 g of dimethyldimethoxysilane (product name KBM-22, commercially available from Shin-Etsu Chemical Co., Ltd.) was added and then additionally heated at 63° C. for 3 hours, and 0.46 g (0.9 mmol per 100 g of SiO₂ of silica particles) of n-tripentylamine was then added.

Then, n-butyl acetate was supplied while the solvent was distilled off by evaporation in a rotary evaporator at a decompression degree of 500 to 80 Torr and a bath temperature of 80° C., the dispersion medium of the sol was substituted with n-butyl acetate to obtain a transparent colloid-colored n-butyl acetate-dispersed silica sol (44.0% by mass of SiO₂, a viscosity (20° C.) of 3.6 mPa·s, 0.02% by mass of water, 0.2% by mass of methanol, 4% by mass of n-butyl alcohol, an average particle diameter (determined by a dynamic light scattering method) of 16 nm of silica particles measured after dilution with n-butyl acetate, an amount of methoxy groups bonded to silica particles of 0.43 groups/nm², and an amount of butoxy groups bonded to silica particles of 0.27 groups/nm²). The molar ratio (Si—OR¹)/(Si—OR⁰) was 0.63. However, —OR¹ is a butoxy group, and —OR⁰ is a methoxy group.

In addition, the content of the amine was 0.61 mmol per 100 g of SiO₂ of silica particles.

The pH of a liquid obtained by mixing the silica sol, methanol and pure water at a mass ratio of 1:1:1 was measured with a pH meter and found to be 5.2.

Even after this sol was put into a sealed glass container and maintained at 50° C. for 4 weeks, there was no increase in viscosity.

### Example 5

800 g of the methanol-dispersed silica sol prepared in the same manner as in Example 3 was put into a 1 L eggplant flask, and while stirring the sol with a magnetic stirrer, 31.5 g of methyltrimethoxysilane (product name KBM-13, commercially available from Shin-Etsu Chemical Co., Ltd.) was added, the mixture was heated at a liquid temperature of 50° C. for 3 hours, 240 g of n-butyl acetate was then supplied while distilling at a pressure of 500 Torr in a rotary evaporator, and a part of the dispersion medium of the sol was substituted with butyl acetate. Next, while stirring the sol with a magnetic stirrer, 18.2 g of dimethyldimethoxysilane (product name KBM-22, commercially available from Shin-Etsu Chemical Co., Ltd.) was added, the mixture was additionally heated at 63° C. for 3 hours, 8.0 g of hexamethyldisiloxane was then added, and the mixture was heated at 60° C. for 2 hours. After cooling, 0.49 g (0.9 mmol per 100 g of SiO₂ of silica particles) of n-tripentylamine was added to the reaction solution with stirring.

Then, n-butyl acetate was supplied while the solvent was distilled off by evaporation in a rotary evaporator at a decompression degree of 450 to 80 Torr and a bath temperature of 80° C., and the dispersion medium of the sol was substituted with n-butyl acetate to obtain a transparent colloid-colored n-butyl acetate-dispersed silica sol (43.5% by mass of SiO₂, a viscosity (20° C.) of 4.9 mPa·s, 0.02% by mass of water, 0.4% by mass of methanol, 1.5% by mass of n-butyl alcohol, an average particle diameter (determined by a dynamic light scattering method) of 19 nm of silica particles measured after dilution with n-butyl acetate, an amount of methoxy groups bonded to silica particles of 0.27 groups/nm², and an amount of butoxy groups bonded to silica particles of 0.05 groups/nm²). The molar ratio (Si—OR¹)/(Si—OR⁰) was 0.19. However, —OR¹ is a butoxy group, and —OR⁰ is a methoxy group.

The pH of a liquid obtained by mixing the silica sol, methanol and pure water at a mass ratio of 1:1:1 was measured with a pH meter and found to be 4.7.

Even after this sol was put into a sealed glass container and maintained at 50° C. for 4 weeks, there was no increase in viscosity.

### Example 6

A methanol-dispersed silica sol (with an average primary particle diameter of 80 nm, a silica concentration of 30% by mass, 1.5% of water, commercially available from Nissan Chemical Corporation) was prepared.

1, 000 g of the methanol sol was put into a 2 L eggplant flask and concentrated in a rotary evaporator at a pressure of 300 Torr and a bath temperature of 60° C. until the SiO₂ content reached 35% by mass, and ethyl acetate was then added to adjust the SiO₂ content to 30% by mass to obtain a methanol-ethyl acetate mixed solvent sol.

Next, while stirring the mixed solvent sol with a magnetic stirrer, 20.0 g of hexamethyldisiloxane was added and the mixture was then maintained at a liquid temperature of 60° C. for 4 hours. After cooling, 0.3 g (0.43 mmol per 100 g of SiO₂ of silica particles) of n-tripentylamine was added to the reaction solution with stirring.

Then, ethyl acetate was supplied while the solvent was distilled off by evaporation in a rotary evaporator at a pressure of 500 Torr and a bath temperature of 80° C., and the dispersion medium of the sol was substituted with ethyl acetate to obtain an ethyl acetate-dispersed silica sol (30.6% by mass of SiO₂, a viscosity (20° C.) of 1.5 mPa·s, 0.06% by mass of water, 0.05% by mass of methanol, 0.02% by mass of ethanol, an average particle diameter (determined by a dynamic light scattering method) of 121 nm of silica particles, an amount of methoxy groups bonded to silica particles of 0.34 groups/nm² and an amount of ethoxy groups bonded to silica particles of 0.01 groups/nm²). The molar ratio (Si—OR¹)/(Si—OR⁰) was 0.029. However, —OR¹ is an ethoxy group, and —OR⁰ is a methoxy group.

The pH of a liquid obtained by mixing the silica sol, methanol and pure water at a mass ratio of 1:1:1 was measured with a pH meter and found to be 4.5.

Even after this sol was put into a sealed glass container and maintained at room temperature or 50° C. for 4 weeks, there was no increase in viscosity.

### Example 7

A water-dispersed silica sol (with an average primary particle diameter of 12 nm determined by a BET method, a pH of 3, and a silica concentration of 33.5% by mass, commercially available from Nissan Chemical Corporation) was prepared.

300 g of the silica sol was put into a 500 ml eggplant flask, and while charging ethanol, distillation was performed at a pressure of 140 Torr and a bath temperature of 80° C. to obtain a sol containing 30.4% by mass of SiO₂ and 12.4% by mass of water.

While stirring the sol with a magnetic stirrer, 14.5 g of phenyltriethoxysilane (product name KBE-103, commercially available from Shin-Etsu Chemical Co., Ltd.) was added, and the mixture was then maintained at a liquid temperature of 67° C. for 2 hours. Then, heating was interrupted, 0.32 g (3.2 mmol per 100 g of SiO₂ of silica particles) of diisopropylamine was added, and the mixture was additionally heated at a liquid temperature of 67° C. for 1 hour. Then, PGMEA was supplied while the solvent was distilled off by evaporation in a rotary evaporator at a pressure of 140 to 65 Torr and a bath temperature of 85 to 95° C., and the dispersion medium of the sol was substituted with PGMEA to obtain a transparent colloid-colored PGMEA-dispersed silica sol (30.5% by mass of SiO₂, a viscosity (20° C.) of 3.8 mPa·s, 0.06% by mass of water, 0.1% by mass of 1-methoxy-2-propanol, an average particle diameter (determined by a dynamic light scattering method) of 23 nm of silica particles measured after dilution with PGMEA, an amount of ethoxy groups bonded to silica particles of 0.01 groups/nm², and an amount of 1-methoxy-2-propoxy groups bonded to silica particles of 0.34 groups/nm²). The molar ratio (Si—OR¹)/(Si—OR⁰) was 34. However, —OR¹ is a 1-methoxy-2-propoxy group, and —OR⁰ is an ethoxy group.

The pH of a liquid obtained by mixing the silica sol, methanol and pure water at a mass ratio of 1:1:1 was measured with a pH meter and found to be 6.1.

Even after this sol was put into a sealed glass container and maintained at 50° C. for 4 weeks, there was no increase in viscosity or particle diameter (determined by a dynamic light scattering method).

### Comparative Example 1

A PGMEA-dispersed silica sol (30.5% by mass of SiO₂, a viscosity (20° C.) of 6.1 mPa·s, 0.2% by mass of water, 0.2% by mass of methanol, an average particle diameter (determined by a dynamic light scattering method) of 110 nm of silica particles, an amount of trimethylsilyl groups bonded to silica particles of 1.1 groups/nm², an amount of methoxy groups bonded to silica particles of 0.4 groups/nm², and an amount of 1-methoxy-2-propoxy groups bonded to silica particles of 0.06 groups/nm²) was obtained in the same operation as in Example 1 except that no tri-n-octyl amine was added. The molar ratio (Si—OR¹)/(Si—OR⁰) was 0.15. However, —OR¹ is a 1-methoxy-2-propoxy group, and —OR⁰ is a methoxy group. The pH of a liquid obtained by mixing the silica sol, methanol and pure water at a mass ratio of 1:1:1 was measured with a pH meter and found to be 3.6.

After this sol was put into a sealed glass container and maintained at room temperature for 4 weeks, the viscosity was 11.5 mPa·s, and the average particle diameter of silica particles determined by a dynamic light scattering method was 115 nm.

### Comparative Example 2

A transparent colloid-colored n-butyl acetate-dispersed silica sol (40.5% by mass of SiO₂, a viscosity (20° C.) of 3.2 mPa·s, 0.02% by mass of water, 0.02% by mass of methanol, 4% by mass of n-butyl alcohol, a particle diameter (determined by a dynamic light scattering method) of 20 nm measured after dilution with n-butyl acetate, an amount of methoxy groups bonded to silica particles of 0.42 groups/nm², and an amount of butoxy groups bonded to silica particles of 0.70 groups/nm²) was obtained in the same manner as in Example 2 except that no amine was added after substitution with n-butyl acetate. The molar ratio (Si—OR¹)/(Si—OR⁰) was 1.67. However, —OR¹ is a butoxy group, and —OR⁰ is a methoxy group. The pH of a liquid obtained by mixing the silica sol, methanol and pure water at a mass ratio of 1:2:1 was measured with a pH meter and found to be 3.5.

After this sol was put into a sealed glass container and maintained at 50° C. for 4 weeks, the viscosity increased to 6.0 mPa·s, and the average particle diameter of silica particles determined by a dynamic light scattering method increased to 37 nm.

### INDUSTRIAL APPLICABILITY

There are provided a silica sol using a carboxylic acid ester as a dispersion medium and a method for producing the same. The organosilica sol can be treated with a silane on the surfaces of silica particles, and a silica sol having improved stability due to addition of an amine is provided.

1. A silica sol which contains, as dispersoids, silica particles in which an alkoxy group represented by Si—OR¹ (provided that R¹ is a C₂₋₁₀ organic group which arbitrarily has an oxygen atom) is present on or near surfaces of silane-treated silica particles, a solvent containing a carboxylic acid ester having an R²—COO—R¹ structure (provided that R¹ is a C₂₋₁₀ organic group which arbitrarily has an oxygen atom, and R² is a C₁₋₁₀ alkyl group which arbitrarily has an oxygen atom) as a dispersion medium, and an amine.

2. The silica sol according to claim 1,
wherein the dispersoids are silica particles in which at least two types of alkoxy groups represented by Si—OR⁰ and Si—OR¹ (provided that R⁰ is a C₁₋₁₀ organic group which arbitrarily has an oxygen atom, R¹ is a C₂₋₁₀ organic group which arbitrarily has an oxygen atom, and R⁰ and R¹ are not the same chemical group) are present on or near the surfaces of the silane-treated silica particles and which have a molar ratio (Si—OR¹)/(Si—OR⁰) of 0.002 to 50.

3. The silica sol according to claim 1,
wherein the silica particles have an average particle diameter of 5 to 200 nm determined by a dynamic light scattering method.

4. The silica sol according to claim 1,
wherein R¹ is an ethyl group, n-propyl group, isopropyl group, n-butyl group, isobutyl group, s-butyl group, t-butyl group, 1-methoxy-2-propyl group, 1-ethoxy-2-propyl group, or phenyl group.

5. The silica sol according to any one of-claims 1 to 4 claim 1,
wherein R² is a methyl group, ethyl group, or propyl group.

6. The silica sol according to claim 1,
wherein a silane treatment of the silica particles is performed with a hydrolysate of at least one silane compound selected from the group consisting of Formula (1) to Formula (3):
R³ₐSi(R⁴)₄₋ₐ Formula (1)
[R⁵_{b}Si(R⁶)_{3-b}]₂Y_{c} Formula (2)
R⁷_{d}Si(R⁸)_{4-d} Formula (3)
(in Formula (1), each R³ is an alkyl group, a halogenated alkyl group, an alkenyl group, an aryl group, or an organic group having an epoxy group, a (meth)acryloyl group, a mercapto group, an amino group, a ureido group, or a cyano group and is bonded to a silicon atom through an Si—C bond, each R⁴ is an alkoxy group, an acyloxy group, or a halogen group, and a is an integer of 1 to 3, and
in Formula (2) and Formula (3), each of R⁵ and R⁷ is a C₁₃ alkyl group or a C₆₋₃₀ aryl group and is bonded to a silicon atom through an Si—C bond, each of R⁶ and R⁸ is an alkoxy group, an acyloxy group, or a halogen group, Y is an alkylene group, an NH group, or an oxygen atom, b is an integer of 1 to 3, c is an integer of 0 or 1, and d is an integer of 1 to 3).

7. The silica sol according to claim 1,
wherein the amine is a secondary amine or tertiary amine having a total number of carbon atoms of 5 to 35.

8. The silica sol according to claim 7,
wherein pH of a liquid obtained by mixing the silica sol that contains the amine, methanol and pure water at a mass ratio of 1:1:1 to 1:2:1 is 4.0 to 9.5.

9. A method for producing the silica sol according to claim 1, comprising
the following step (A) to step (B), the following step (A-1) between completion of the step (A) and commencement of the step (B) or during the step (B), and the following step (A-2) after completion of the step (A-1):
a step (A): a step of obtaining a silica sol containing silica particles having an average particle diameter of 5 to 200 nm determined by a dynamic light scattering method as dispersoids, and an alcohol R⁰OH (provided that R⁰ is a C₁-10 organic group which arbitrarily has an oxygen atom) as a dispersion medium,
a step (B): a step of removing some or all of R⁰OH from the silica sol obtained in the step (A) and adding a carboxylic acid ester having an R²—COO—R¹ structure (provided that R is a C₂₋₁₀ organic group which arbitrarily has an oxygen atom, and R² is a C₁₋₁₀ alkyl group),
a step (A-1): a step of treating the silica particles contained in the silica sol obtained in the step (A) with at least one silane compound of Formula (1) to Formula (3), and a step (A-2): a step of adding a secondary amine or tertiary amine having a total number of carbon atoms of 5 to 35 to the silica sol obtained in the step (A-1).

10. The method for producing the silica sol according to claim 9,
wherein the step (A) is a step of obtaining a silica sol containing silica particles having an average particle diameter of 5 to 200 nm determined by a dynamic light scattering method as dispersoids, and an alcohol R⁰OH (provided that R⁰ is a C₁₋₁₀ organic group which arbitrarily has an oxygen atom) as a dispersion medium, and
wherein the step (B) is a step of removing some or all of the alcohol R⁰O^{H} of the silica sol obtained in the step (A) and adding a carboxylic acid ester having an R²—COO—R¹ structure (provided that R¹ is a C₂₋₁₀ organic group which arbitrarily has an oxygen atom, R² is a C₁₋₁₀ alkyl group, and R⁰ and R¹ are not the same chemical group).
